(19) United States
(12) Patent Application Publication
(10) Pub. No.: US 2022/0398313 A1
(43) Pub. Date: Dec. 15, 2022

(54) THREAT AWARE DATA PROTECTION

(71) Applicant: EMC IP Holding Company LLC, Hopkinton, MA (US)

(72) Inventors: Savitha Susan Bijoy, Trivandrum (IN); Gururaj Kulkarni, Bangalore (IN); Mahesh Kamath, Bangalore (IN); Kiran Kumar Malle Gowda, Bangalore (IN)

(21) Appl. No.: 17/385,128

(22) Filed: Jul. 26, 2021

(30) Foreign Application Priority Data
Jun. 11, 2021 (IN) 202141026170

(51) Int. Cl. G06F 21/55; G06F 21/60; G06F 11/14

(52) U.S. Cl. CPC G06F 21/554; G06F 21/604; G06F 11/1448; G06F 2221/034

(57) ABSTRACT

A method and system for threat aware data protection. Threat awareness intelligence, directed to preventing information or cyber security issues, are becoming a critical requirement for data protection (or backup) services. Accordingly, a centralized policy framework is proposed through which threat evaluations may be performed synchronously, as well as asynchronously, with data backup operations to ensure the ingestion of threat-free data into backup storage.

### BACKGROUND

Threat awareness intelligence, directed to preventing information or cyber security issues, are becoming a critical requirement for data protection (or backup) services.

### SUMMARY

In general, in one aspect, the invention relates to a method for threat awareness data protection. The method includes instructing a threat agent to perform a threat evaluation of an asset residing on an asset source, receiving, from the threat agent and following the threat evaluation, a threat evaluation report comprising an incident, analyzing the incident to derive an actionable response, and applying the actionable response.

In general, in one aspect, the invention relates to a non-transitory computer readable medium (CRM). The non-transitory CRM includes computer readable program code, which when executed by a computer processor, enables the computer processor to perform a method for threat awareness data protection. The method includes instructing a threat agent to perform a threat evaluation of an asset residing on an asset source, receiving, from the threat agent and following the threat evaluation, a threat evaluation report comprising an incident, analyzing the incident to derive an actionable response, and applying the actionable response.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart describing a method for threat aware data protection in accordance with one or more embodiments of the invention.

FIG. 3 shows a flowchart describing a method for performing threat evaluations in accordance with one or more embodiments of the invention.

FIG. 4 shows an exemplary computing system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

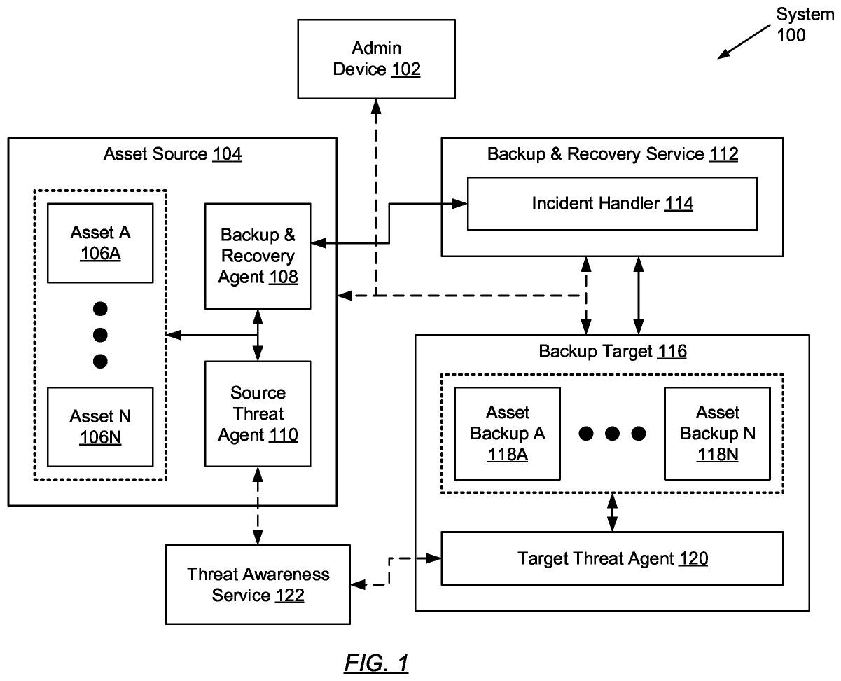

In the following description of FIGS. 1-4, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for threat aware data protection. Threat awareness intelligence, directed to preventing information or cyber security issues, are becoming a critical requirement for data protection (or backup) services. Accordingly, a centralized policy framework is proposed hereinafter through which threat evaluations may be performed synchronously, as well as asynchronously, with data backup operations to ensure the ingestion of threat-free data into backup storage.

FIG. 1 shows a system in accordance with one or more embodiments of the invention. The system (100) may include an admin device (102), an asset source (104), a backup and recovery service (112), and a backup target (116). Optionally, the system (100) may further include a threat awareness service (122). Each of these system (100) components is described below.

In one embodiment of the invention, the admin device (102) may represent any physical appliance or computing system operated by one or more administrators of the system (100). An administrator may refer to an individual or entity whom may be responsible for overseeing system (100) operations and maintenance. To that extent, and at least as it pertains to embodiments of the invention, the admin device (102) may include functionality to enable an administrator to: register an asset source (104) and/or a backup target (116) with the backup and recovery service (112); submit protection policies, concerning one or more assets on the asset source (104) and/or one or more asset backups on the backup target (116), to the backup and recovery service (112); and receive reports, following the application of submitted protection policies, from the backup and recovery service (112). One of ordinary skill will appreciate that the admin device (102) may perform other functionalities without departing from the scope of the invention.

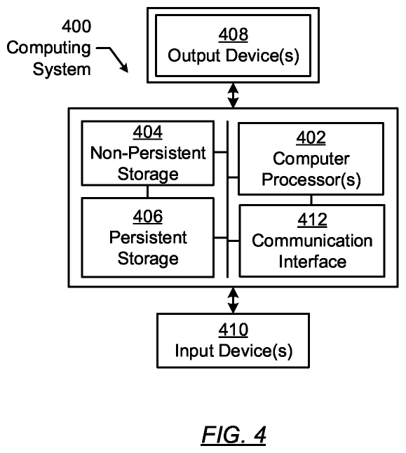

In one embodiment of the invention, the asset source (104) may represent any physical appliance or computing system designed and configured to receive, generate, process, store, and/or transmit data, as well as to provide an environment in which one or more computer programs may execute thereon. The computer programs may, for example, implement large-scale and complex data processing; or implement one or more services offered locally or over a network. Further, in providing an execution environment for any computer program(s) installed thereon, the asset source (104) may include and allocate various resources (e.g., computer processors, memory, storage, virtualization, network bandwidth, etc.), as needed, to the computer program(s) and the workloads instantiated thereby. One of ordinary skill will appreciate that the asset source (104) may perform other functionalities without departing from the scope of the invention. Examples of the asset source (104) may include, but are not limited to, a desktop computer, a laptop computer, a server, a mainframe, or any other computing system similar to the exemplary computing system shown in FIG. 4. Moreover, the asset source (104) may include one or more assets (106A-106N), a backup and recovery agent (108), and a source threat agent (110). Each of these asset source (104) subcomponents is described below.

In one embodiment of the invention, an asset (106A-106N) may refer to a database, or any logical container to and from which data (and/or metadata thereof), which has been received by or generated on the asset source (104), may be stored and retrieved, respectively. An asset (106A-106N) may occupy any portion of persistent storage (not shown) available on the asset source (104). Examples of persistent storage may include, but are not limited to, optical storage, magnetic storage, NAND Flash Memory, NOR Flash Memory, Magnetic Random Access memory (M-RAM), Spin Torque Magnetic RAM (ST-MRAM), Phase Change Memory (PCM), or any other storage defined as non-volatile Storage Class memory (SCM).

In one embodiment of the invention, the backup and recovery agent (108) may refer to a computer program that may execute on the underlying hardware of the asset source (104), which may be responsible for facilitating backup and recovery operations targeting one or more assets (106A-106N) on the asset source (104). To that extent, the backup and recovery agent (108) may protect one or more assets (106A-106N) against data loss (i.e., backup the targeted data and/or metadata); and reconstruct one or more assets (106A-106N) following such data loss (i.e., recover the targeted data and/or metadata). Further, one of ordinary skill will appreciate that the backup and recovery agent (108) may perform other functionalities without departing from the scope of the invention.

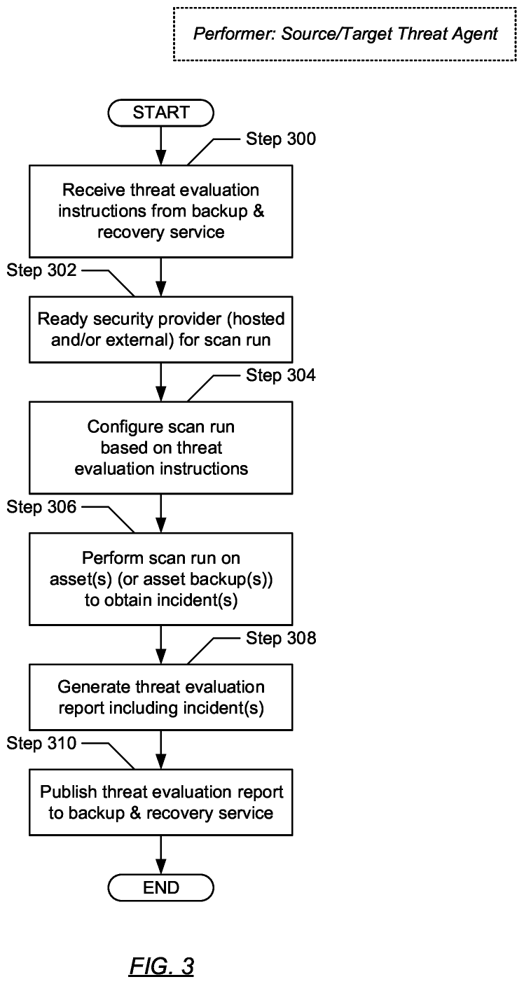

In one embodiment of the invention, the source threat agent (110) may refer to a computer program that may execute on the underlying hardware of the asset source (104), which may be responsible for executing threat evaluations targeting one or more assets (106A-106N) on the asset source (104). A threat evaluation may refer to a security operation that scans data (and/or metadata thereof) for known information or cyber security threats and malicious behavior. Any threat evaluation may rely on tools and/or solutions from a hosted (not shown) or external (e.g., threat awareness service (122)) security provider, which may be invoked by the source threat agent (110). To that extent, the source threat agent (110) may include functionality to perform the method outlined and described through FIG. 3, below. Further, one of ordinary skill will appreciate that the source threat agent (110) may perform other functionalities without departing from the scope of the invention.

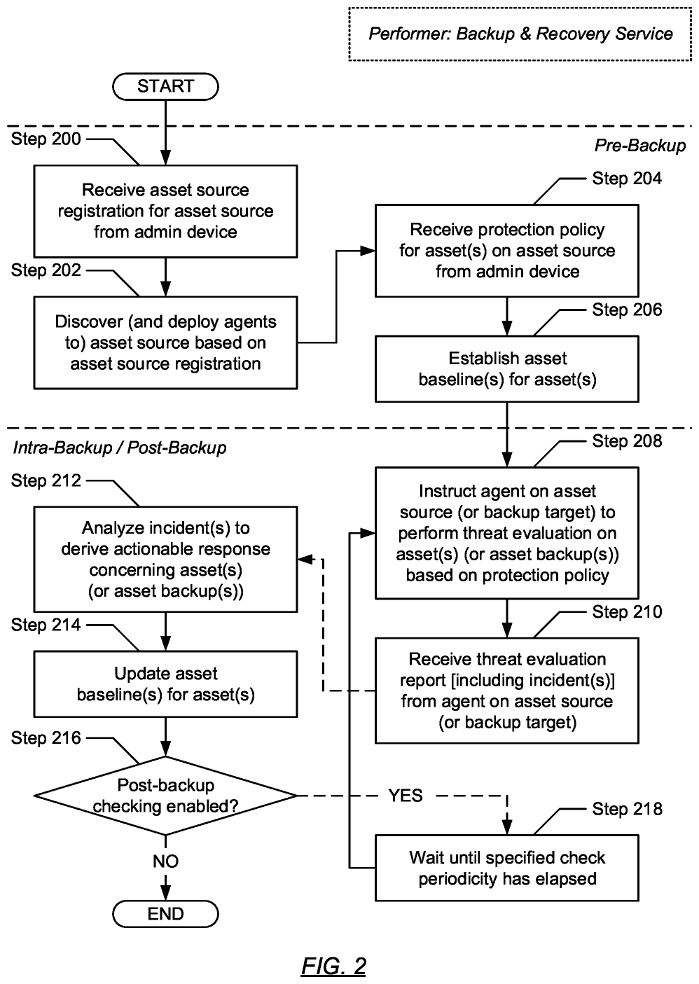

In one embodiment of the invention, the backup and recovery service (112) may represent information technology (IT) infrastructure configured for managing backup and/or recovery operations between the asset source (104) and the backup target (116), as well as managing threat aware data protection in accordance with one or more embodiments of the invention. To that extent, the backup and recovery service (112) may include functionality to perform the method outlined and described through FIG. 2, below. One of ordinary skill, however, will appreciate that the backup and recovery service (112) may perform other functionalities without departing from the scope of the invention. Furthermore, the backup and recovery service (112) may be implemented using one or more servers (not shown). Each server may represent a physical or virtual server, which may reside in an enterprise data center, a cloud computing environment, or any hybrid infrastructure thereof. Additionally, or alternatively, the backup and recovery service (112) may be implemented using one or more computing systems similar to the exemplary computing system shown in FIG. 4. Moreover, the backup and recovery service (112) may include an incident handler (114), which is described below.

In one embodiment of the invention, the incident handler (114) may refer to a computer program that may execute on the underlying hardware of the backup and recovery service (112), which may be responsible for incident response, triage, and/or investigation. An incident may refer to an information or cyber security event of malicious intent—i.e., an information or cyber security attack. Examples of incidents may include, but are not limited to, malware infections, distributed denial of service diversions, unauthorized accesses, insider breaches, unauthorized privilege escalations, destructive attacks, and advanced persistent threat or multi-state attacks. In responding to, triaging, and/or investigating incidents, the incident handler (114) may include functionality to deploy any number of strategies directed to mitigating, preventing, and/or removing the incidents (or the sources thereof). One of ordinary skill will appreciate that the incident handler (114) may perform other functionalities without departing from the scope of the invention.

In one embodiment of the invention, the backup target (116) may represent any data backup, archiving, and/or disaster recovery storage system. The backup target (116) may be implemented using one or more servers (not shown) (or computing systems similar to the exemplary computing system shown in FIG. 4)—each of which may house one or many storage devices for storing data. The storage device(s) may, at least in part, include persistent storage—examples of which may include, but are not limited to, optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM). Moreover, the backup target (116) may include one or more asset backups (118A-118N), and a target threat agent (120). Each of these backup target (116) subcomponents is described below.

In one embodiment of the invention, an asset backup (118A-118N) may refer to a database, or any logical container to and from which a copy of data (and/or metadata thereof), pertaining to a given asset (106A-106N), may be stored and retrieved, respectively. An asset backup (118A-118N) may occupy any portion of persistent storage (not shown) available on the backup target (116).

In one embodiment of the invention, the target threat agent (120) may refer to a computer program that may execute on the underlying hardware of the backup target (116), which may be responsible for executing threat evaluations targeting one or more asset backups (118A-118N) on the backup target (116). As mentioned above, a threat evaluation may refer to a security operation that scans data (and/or metadata thereof) for known information or cyber security threats and malicious behavior. Any threat evaluation may rely on tools and/or solutions from a hosted (not shown) or external (e.g., threat awareness service (122)) security provider, which may be invoked by the target threat agent (120). To that extent, the target threat agent (120) may include functionality to perform the method outlined and described through FIG. 3, below. Further, one of ordinary skill will appreciate that the target threat agent (120) may perform other functionalities without departing from the scope of the invention.

In one embodiment of the invention, the threat awareness service (122) may represent IT infrastructure configured as an external or third-party security provider. Generally, a security provider may refer to a collection or suite of software utilities programmed to detect, mitigate, and/or remove a variety of information or cyber security threats. To that extent, the threat awareness service (122) (if available) may be employed, by the source threat agent (110) and/or the target threat agent (120), to facilitate the execution of threat evaluations. Furthermore, the threat awareness service (122) may be implemented using one or more servers (not shown). Each server may represent a physical or virtual server, which may reside in an enterprise data center, a cloud computing environment, or any hybrid infrastructure thereof. Additionally, or alternatively, the threat awareness service (122) may be implemented using one or more computing systems similar to the exemplary computing system shown in FIG. 4.

In one embodiment of the invention, the above-mentioned system (100) components (or subcomponents thereof) may communicate with one another through a network (not shown) (e.g., a local area network (LAN), a wide area network (WAN) such as the Internet, a mobile network, any other network type, or a combination thereof). The network may be implemented using any combination of wired and/or wireless connections. Further, the network may encompass various interconnected, network-enabled subcomponents (or systems) (e.g., switches, routers, etc.) that may facilitate communications between the above-mentioned system (100) components (or subcomponents thereof). Moreover, in communicating with one another, the above-mentioned system (100) components (or subcomponents thereof) may employ any combination of wired and/or wireless communication protocols.

While FIG. 1 shows a configuration of components, other system (100) configurations may be used without departing from the scope of the invention. For example, the system (100) may include more than one asset source (not shown) and/or more than one backup target (not shown). By way of another example, the backup target (116) may exclude the target threat agent (120), where responsibilities and/or functionalities (described above) pertaining to the target threat agent (120) may be assumed by the source target agent (110).

FIG. 2 shows a flowchart describing a method for threat aware data protection in accordance with one or more embodiments of the invention. The various steps outlined below may be performed by the backup and recovery service (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 2, in Step 200, an asset source registration, for an asset source (see e.g., FIG. 1), is received from an admin device. In one embodiment of the invention, the asset source registration may refer to connection information for the asset source. Connection information may entail information necessary to connect to and/or interact with the asset source, which may include, but is not limited to: an Internet Protocol (IP) address assigned to the asset source; a network port number of the asset source through which a connection thereto may be attempted; and authentication information (e.g., authentication mode, username or login, and password) for accessing the asset source.

In Step 202, based on the asset source registration (received in Step 200), the asset source is discovered and agents are deployed thereto. In one embodiment of the invention, discovering the asset source may entail establishing a connection with and successfully accessing the asset source using the provided connection information. Further, agents deployed to and/or installed on the asset source may include, but are not limited to, a backup and recovery agent and a source threat agent (both described above) (see e.g., FIG. 1).

In Step 204, a protection policy, for one or more assets (described above) (see e.g., FIG. 1) on the asset source, is received from the admin device. In one embodiment of the invention, the protection policy may refer to a collection of rules and/or preferences directed to protecting asset (or asset backup) data and/or metadata against information or cyber security threats. The rules and/or preferences specified in/by the protection policy may include, but are not limited to: which threat defender(s) (described below) should be applied to the asset (or asset backup) data and/or metadata while performing a threat evaluation; whether the security provider (described above) (see e.g., FIG. 1), facilitating a threat evaluation, encompasses hosted or external/third-party tools and utilities; whether a threat evaluation is to be performed synchronously with a backup operation targeting the asset data and/or metadata; whether post-backup checking (described below) is to be scheduled or enabled, and a desired periodicity associated with the post-backup checking if enabled; one or more actionable responses (described below), to be applied to the scanned asset (or asset backup) data and/or metadata, based on the incident(s) detected by way of a threat evaluation; and whether to enable one or more scan run optimizations (e.g., specifying a threshold or maximum time allowed to perform a scan run to reduce resource consumption, excluding unmodified elements (i.e., file(s) or any other granularity) of the asset (or asset backup) data and/or metadata from a scan run to further reduce resource utilization, etc.).

In one embodiment of the invention, a threat defender may refer to software or computer readable program code configured to scan for and detect a particular threat (or class thereof) across targeted asset (or asset backup) data and/or metadata. Further, various threat defenders may be available amongst the arsenal of threat protection tools and/or utilities offered by a security provider (described above) (see e.g., FIG. 1). By way of an example, a threat defender may focus on the detection of intrusion threats (e.g., ransomware, phishing attacks, hacking, etc.). By way of another example, a threat defender may focus on the detection of malware threats.

In Step 206, an asset baseline, for the asset(s) associated with the protection policy (received in Step 204), is established. In one embodiment of the invention, the asset baseline may encompass a current state of the asset(s) captured at a given point-in-time. Through consistent capture and/or updating of the asset baseline, false positives and/or negatives, pertinent to the detection of threats, can be minimized, if not eliminated.

In Step 208, based on the protection policy (received in Step 204), the source threat agent (deployed to the asset source in Step 202) is instructed to perform a threat evaluation of the asset(s). In one embodiment of the invention, the threat evaluation may transpire synchronously (i.e., at the same time or during) with a backup operation targeting the asset(s), where the backup operation may be facilitated by the backup and recovery agent (also deployed to the asset source in Step 202).

In another embodiment of the invention, based on the protection policy (received in Step 204), a target threat agent on a backup target may be instructed to perform a threat evaluation of the asset backup(s) pertaining to the asset(s). In such an embodiment, the threat evaluation may transpire following a recent backup operation or in-between periodic backup operations (i.e., asynchronously) targeting the asset(s).

In Step 210, following the threat evaluation (instructed to be performed in step 208), a threat evaluation report is received. In one embodiment of the invention, the threat evaluation report may be submitted by the source threat agent on the asset source, and may specify one or more incidents concerning the asset(s). In another embodiment of the invention, the threat evaluation report may be submitted by the target threat agent on the backup target, and may alternatively specify one or more incidents concerning the asset backup(s) of the asset(s). An incident, concerning an asset (or asset backup), may refer to an information or cyber security event of malicious intent—i.e., an information or cyber security attack. Examples of incidents may include, but are not limited to, malware infections, distributed denial of service diversions, unauthorized accesses, insider breaches, unauthorized privilege escalations, destructive attacks, and advanced persistent threat or multi-state attacks.

In Step 212, the incident(s) (specified in the threat evaluation report received in Step 210) is/are analyzed to derive an actionable response. In one embodiment of the invention, the actionable response may include, but is not limited to: quarantining infected asset (or asset backup) data and/or metadata; proceeding in storing non-infected asset (or asset backup) data and/or metadata onto the backup target, or recovering non-infected asset (or asset backup) data and/or metadata onto the asset source; raising alerts via notification channels when infected asset (or asset backup) data and/or metadata is/are discovered; integrating with other security agents to enable further actions in a network (or user) management stack upstream; and invalidating any infected asset (or asset backup) data and/or metadata.

In Step 214, the asset baseline (established in Step 206 or updated in a previous iteration of Step 214) is updated.

In Step 216, a determination is made as to whether post-backup checking is enabled. Post-backup checking may refer to the on-demand performance of threat evaluation(s) following a recent backup operation or in-between periodic backup operations targeting the asset(s). Specifically, the threat evaluation(s) may be applied to the asset backup(s), stored on the backup target, associated with the asset(s). Further, in one embodiment of the invention, if it is determined that post-backup checking is enabled, then the method proceeds to Step 218. On the other hand, in another embodiment of the invention, if it is alternatively determined that post-backup checking is disabled, then the method alternatively ends.

In Step 218, following the determination (in Step 216) that post-backup checking is enabled, waiting for a specified periodicity, associated with a post-backup or inter-backup threat evaluation, to transpire occurs. Thereafter, the method proceeds to Step 208, where instructions for performing another threat evaluation of the asset(s) (or asset backup(s)) are provided based on the protection policy (received in Step 204).

FIG. 3 shows a flowchart describing a method for performing threat evaluations in accordance with one or more embodiments of the invention. The various steps outlined below may be performed by the source threat agent deployed onto an asset source, or the target threat agent deployed onto a backup target (see e.g., FIG. 1). Further, while the various steps in the flowchart are presented and described sequentially, one of ordinary skill will appreciate that some or all steps may be executed in different orders, may be combined or omitted, and some or all steps may be executed in parallel.

Turning to FIG. 3, in Step 300, threat evaluation instructions are received from a backup and recovery service (described above) (see e.g., FIG. 1). In one embodiment of the invention, the threat evaluation instructions may pertain to the execution of a threat evaluation of one or more assets residing on an asset source, where the threat evaluation may be performed synchronously with the execution a backup operation targeting the asset(s). In another embodiment of the invention, the threat evaluation instructions may pertain to the execution of a threat evaluation of one or more asset backups stored on a backup target (following the backup operation of the associated asset(s)).

In Step 302, a security provider is readied for a scan run. In one embodiment of the invention, a security provider may refer to a collection or suite of software utilities programmed to detect, mitigate, and/or remove a variety of information or cyber security threats. Further, the security provider may be hosted on the asset source, may be hosted on the backup target, or may preside externally to either (as a third-party entity).

In Step 304, the above-mentioned scan run is configured based on at least a portion of the threat evaluation instructions (received in Step 300). Specifically, in one embodiment of the invention, the threat evaluation instructions may encompass data protection rules and/or preferences that may include, but are not limited to: which threat defender(s) (described below) should be applied to the asset (or asset backup) data and/or metadata while performing a threat evaluation; whether the security provider (described above) (see e.g., FIG. 1), facilitating a threat evaluation, encompasses hosted or external/third-party tools and utilities; whether a threat evaluation is to be performed synchronously with a backup operation targeting the asset data and/or metadata; whether post-backup checking (described below) is to be scheduled or enabled, and a desired periodicity associated with the post-backup checking if enabled; one or more actionable responses (described below), to be applied to the scanned asset (or asset backup) data and/or metadata, based on the incident(s) detected by way of a threat evaluation; and whether to enable one or more scan run optimizations (e.g., specifying a threshold or maximum time allowed to perform a scan run to reduce resource consumption, excluding unmodified elements (i.e., file(s) or any other granularity) of the asset (or asset backup) data and/or metadata from a scan run to further reduce resource utilization, etc.).

In Step 306, the scan run (configured in Step 304) is performed. In one embodiment of the invention, the scan run may be applied to one or more assets residing on the asset source, for which a backup operation is synchronously being performed. In another embodiment of the invention, the scan run may be applied, at a specified periodicity, to one or more asset backups stored on the backup target. Further, following the performance of the scan run, one or more incidents may be obtained or detected, which pertain to the asset(s) or the asset backup(s). An incident may refer to an information or cyber security event of malicious intent—i.e., an information or cyber security attack.

In Step 308, a threat evaluation report is generated. In one embodiment of the invention, the threat evaluation report may include or specify the incident(s) (obtained or detected in Step 306). Thereafter, in Step 310, the threat evaluation report (generated in Step 308) is published or provided to the backup and recovery service, and in response to the threat evaluation instructions (received therefrom in Step 300).

FIG. 4 shows an exemplary computing system in accordance with one or more embodiments of the invention. The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a central processing unit (CPU) and/or a graphics processing unit (GPU). The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment of the invention, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for threat awareness data protection, comprising:
instructing a threat agent to perform a threat evaluation of an asset residing on an asset source;
receiving, from the threat agent and following the threat evaluation, a threat evaluation report comprising an incident;
analyzing the incident to derive an actionable response; and
applying the actionable response.

2. The method of claim 1, wherein performance of the threat evaluation is based on a protection policy for the asset.

3. The method of claim 2, wherein the protection policy comprises a collection of rules and preferences directed to protecting asset data and metadata against cyber security threats.

4. The method of claim 3, wherein the collection of rules and preferences comprises at least one scan run optimization of a group of scan run optimizations consisting of specifying a maximum time allowed to perform a scan run, and excluding unmodified elements of the asset data and metadata from the scan run.

5. The method of claim 1, wherein the incident captures a detection of at least one of a group of cyber security threats consisting of malware infections, distributed denial of service diversions, unauthorized accesses, insider breaches, unauthorized privilege escalations, destructive attacks, and advanced persistent threat attacks.

6. The method of claim 1, wherein the actionable response comprises quarantining infected asset data and metadata.

7. The method of claim 6, wherein the actionable response further comprises storing non-infected asset data and metadata onto a backup target as an asset backup associated with the asset.

8. The method of claim 1, wherein the threat agent is instructed to perform the threat evaluation of the asset synchronously with a backup operation targeting the asset.

9. The method of claim 1, further comprising:
making a determination that post-backup checking is enabled;
based on the determination:
instructing the threat agent to perform a second threat evaluation of an asset backup stored on a backup target;
receiving, from the threat agent and following the second threat evaluation, a second threat evaluation report comprising a second incident;
analyzing the second incident to derive a second actionable response; and
applying the second actionable response.

10. The method of claim 1, wherein the asset backup comprises a copy of threat-free data and metadata pertaining to the asset.

11. A non-transitory computer readable medium (CRM) comprising computer readable program code, which when executed by a computer processor, enables the computer processor to perform a method for threat awareness data protection, the method comprising:
instructing a threat agent to perform a threat evaluation of an asset residing on an asset source;
receiving, from the threat agent and following the threat evaluation, a threat evaluation report comprising an incident;
analyzing the incident to derive an actionable response; and
applying the actionable response.

12. The non-transitory CRM of claim 11, wherein performance of the threat evaluation is based on a protection policy for the asset.

13. The non-transitory CRM of claim 12, wherein the protection policy comprises a collection of rules and preferences directed to protecting asset data and metadata against cyber security threats.

14. The non-transitory CRM of claim 13, wherein the collection of rules and preferences comprises at least one scan run optimization of a group of scan run optimizations consisting of specifying a maximum time allowed to perform a scan run, and excluding unmodified elements of the asset data and metadata from the scan run.

15. The non-transitory CRM of claim 11, wherein the incident captures a detection of at least one of a group of cyber security threats consisting of malware infections, distributed denial of service diversions, unauthorized accesses, insider breaches, unauthorized privilege escalations, destructive attacks, and advanced persistent threat attacks.

16. The non-transitory CRM of claim 11, wherein the actionable response comprises quarantining infected asset data and metadata.

17. The non-transitory CRM of claim 16, wherein the actionable response further comprises storing non-infected asset data and metadata onto a backup target as an asset backup associated with the asset.

18. The non-transitory CRM of claim 11, wherein the threat agent is instructed to perform the threat evaluation of the asset synchronously with a backup operation targeting the asset.

19. The non-transitory CRM of claim 11, the method further comprising:
making a determination that post-backup checking is enabled;
based on the determination:
instructing the threat agent to perform a second threat evaluation of an asset backup stored on a backup target;
receiving, from the threat agent and following the second threat evaluation, a second threat evaluation report comprising a second incident;
analyzing the second incident to derive a second actionable response; and
applying the second actionable response.

20. The non-transitory CRM of claim 11, wherein the asset backup comprises a copy of threat-free data and metadata pertaining to the asset.
